(19) United States
(12) Patent Application Publication
(10) Pub. No.: US 2022/0139302 A1
(43) Pub. Date: May 5, 2022

(54) PIXEL DRIVE CONTROL DEVICE AND PIXEL DRIVE CONTROL METHOD

(71) Applicant: Lenovo (Singapore) Pte. Ltd., Singapore (SG)

(72) Inventors: Moriyuki Tsuchihashi, Kanagawa (JP); Kazuo Fujii, Kanagawa (JP); Arimasa Naitoh, Kanagawa (JP)

(73) Assignee: Lenovo (Singapore) Pte. Ltd., Singapore (SG)

(21) Appl. No.: 17/451,368

(22) Filed: Oct. 19, 2021

(30) Foreign Application Priority Data
Oct. 29, 2020 (JP) 2020-181555

(51) Int. Cl. G09G 3/32

(52) U.S. Cl. CPC G09G 3/32; G09G 2320/0626; G09G 2330/023

(57) ABSTRACT

To reduce power consumption when displaying an image by a display device, a pixel drive control device is configured to control driving of an array of pixels in M (M≥2) rows and N (N≥2) columns on a display device, and includes a pixel drive controller configured to control driving a part of pixels in a pixel unit including two or more pixels in m (m≤M) rows and n (n≤N) columns that is set in the array of pixels in the M rows and the N columns.

### CROSS-REFERENCE TO RELATED APPLICATIONS

This application claims priority to Japanese Patent Application No. 2020-181555 filed Oct. 29, 2020, the contents of which are hereby incorporated herein by reference in their entirety.

### TECHNICAL FIELD

The present disclosure relates to a pixel drive control device and a pixel drive control method.

### BACKGROUND

Active-matrix display devices equipped with self-luminous display elements such as organic ELs are known. Such a display device includes a plurality of gate lines extending in the row (horizontal) direction and a plurality of data lines extending in the column (vertical) direction. The pixel circuit corresponding to each of the pixels at the intersections of the gate lines and the data lines includes a display element such as an organic EL, a selection thin film transistor (TFT), a drive TFT, and a storage capacitor. In response to a scanning signal applied to the gate line, the selection TFT turns on, so that the storage capacitor accumulates the charge corresponding to the data signal applied to the data line. The charge accumulated in the storage capacitor then turns on the drive TFT, which supplies electric power to the display element from the power-supply line. This drives the display element to emit light.

### SUMMARY

One or more embodiments of the present disclosure relate to a pixel drive control device that is configured to control driving of an array of pixels in M (M≥2) rows and N (N≥2) columns on a display device, and includes a pixel drive controller configured to control driving a part of pixels in each of pixel units, each of the pixel units including two or more pixels in m (m≤M) rows and n (n≤N) columns and being set in the array of pixels in the M rows and the N columns.

One or more embodiments of the present disclosure relate to a pixel drive control method that controls driving of an array of pixels in M (M≥2) rows and N (N≥2) columns on a display device, and includes controlling to drive a part of pixels in each of pixel units, each of the pixel units including two or more pixels in m (m≤M) rows and n (n≤N) columns and being set in the array of pixels in the M rows and the N columns.

### BRIEF DESCRIPTION OF THE DRAWINGS

FIG. 1 illustrates an example of the hardware configuration of an electronic apparatus.

FIG. 2 illustrates an example of the configuration of a display.

FIG. 3 illustrates an example of the functional configuration of the electronic apparatus, relating to the pixel driving of the display.

FIG. 4 illustrates an example of pixel driving in the normal mode on the display.

FIG. 5 illustrates an example of pixel driving in the low power consumption mode on the display.

FIG. 6 illustrates driving of the pixels in the low power consumption mode in terms of the relationship between the selection lines and the data lines.

FIG. 7 illustrates an example of changing the position of a pixel driven in a pixel unit in the low power consumption mode.

FIG. 8A illustrates an example of the intra-unit pixel driving pattern.

FIG. 8B illustrates another example of the intra-unit pixel driving pattern.

### DETAILED DESCRIPTION

### Embodiments

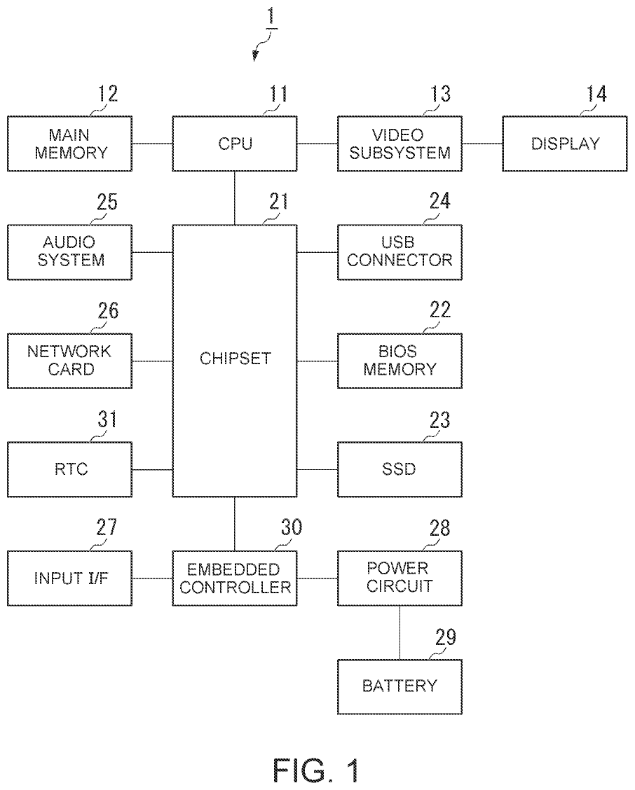

FIG. 1 illustrates an example of the hardware configuration of an electronic apparatus 1 according to the present embodiment.

The electronic apparatus 1 of the present embodiment is a clamshell type personal computer, which is called a laptop personal computer. The electronic apparatus 1 may be of other types, such as a tablet, a mobile phone, a smartphone, and an electronic organizer.

The electronic apparatus 1 in this drawing includes a central processing unit (CPU) 11, a main memory 12, a video subsystem 13, a display 14, a chipset 21, a basic input output system (BIOS) memory 22, a solid state drive (SSD) 23, a universal serial bus (USB) connector 24, an audio system 25, a network card 26, an embedded controller 30, an input interface 27, a power circuit 28, a battery 29, and a real-time clock (RTC) 31.

In one example, the CPU 11 executes a program stored in the main memory 12 to execute various arithmetic processes and control various parts of the electronic apparatus 1. In one example, the main memory 12 includes a plurality of dynamic random access memory (DRAM) chips. The main memory 12 functions as a loading area of a program that the CPU 11 executes. The main memory 12 also functions as a work area for writing the processing data of the program that the CPU 11 executes. Examples of the program that the CPU 11 executes include an operating system (OS), various types of drivers to operate peripherals as hardware, various types of service/utility and application programs.

In one example, the video subsystem 13 includes a video controller and a video memory.

The video subsystem 13 is a subsystem to implement the functions relating to image display. The video controller processes a drawing instruction from the CPU 11, and writes the processed drawing information in the video memory. The video controller also reads drawing information from the video memory and outputs the read drawing information, which is drawing data (display data), to the display 14. The display 14 displays a display screen based on the drawing data (display data) output from the video subsystem 13.

The chipset 21 includes a controller, such as a USB, a serial AT attachment (ATA), a serial peripheral interface (SPI) bus, a peripheral component interconnect (PCI) bus, a PCI-Express bus, or a low pin count (LPC) bus. To the chipset 21, a plurality of devices are connected. In this embodiment, the devices connected to the chipset 21 include the BIOS memory 22, the SSD 23, the USB connector 24, the audio system 25, the network card 26, the embedded controller 30, and the RTC 31.

In one example, the BIOS memory 22 includes a non-volatile memory that is electrically rewritable, such as an electrically erasable programmable read only memory (EEPROM) or a flash ROM. The BIOS memory 22 stores parameters, BIOS, and system firmware to control the embedded controller 30, for example.

The SSD 23 is a storage device. The SSD 23 stores an OS, various types of drivers, various types of services/utilities, application programs, and various types of data.

The USB connector 24 is to connect peripherals with the electronic apparatus 1 using USB. The audio system 25 records, reproduces, and inputs/outputs audio data. The network card 26 connects to a network for data communication. In one example, the network card 26 may connect to a network via a wireless LAN.

Instead of the SSD 23, another storage device such as a hard disk drive (HDD) may be used.

The embedded controller 30 is a one-chip microcomputer to monitor and control various devices (e.g., peripherals and sensors), irrespective of the operating mode of the electronic apparatus 1. The embedded controller 30 includes a CPU, a ROM, and a RAM as well as an A/D input terminal, a D/A output terminal, a timer, and a digital input/output terminal for a plurality of channels, which are not illustrated. In one example, to the digital input/output terminal of the embedded controller 30, the input interface 27 and the power circuit 28 are connected.

The embedded controller 30 has a power-management function to control the power circuit 28. The embedded controller 30 controls the power circuit 28 so as to control the electric power supplied to the CPU 11, for example.

In one example, the input interface 27 includes various types of input devices, such as a keyboard, a pointing device, and a touch pad.

In one example, the power circuit 28 includes a DC/DC converter, a charge-discharge unit, and an AC/DC adaptor. The power circuit 28 operates under the control by the embedded controller 30. The power circuit 28 converts a DC voltage supplied from the AC/DC adapter or the battery 29 into a voltage to let the electronic apparatus 1 operate. The power circuit 28 supplies electric power at the converted voltage to various parts of the electronic apparatus 1.

The battery 29 is a secondary battery and is charged by the power circuit 28. The electric power stored in the battery 29 is charged under the control by the power circuit 28 to be supplied to various parts of the electronic apparatus 1.

The RTC 31 measures the date and time. Receiving power supply from a backup battery, for example, the RTC 31 is able to constantly measure the date and time even after the electronic apparatus 1 is shut down and the power supply from the power circuit 28 stops.

The display 14 in this embodiment is configured as a μ(micro) light emitting diode (LED) display. The μLED display is a self-luminous display device that includes minute LEDs of several tens of μm as display elements, for example.

The μLED display displays an image by driving the pixels in an active matrix way. For color display, the μLED display includes LEDs each corresponding to R, G, or B for one pixel.

The display 14 of this embodiment is configured to drive the pixels in number corresponding to the resolution of 3840×2160 to enable a display compatible with the ultra high definition (UHD) standard for image display.

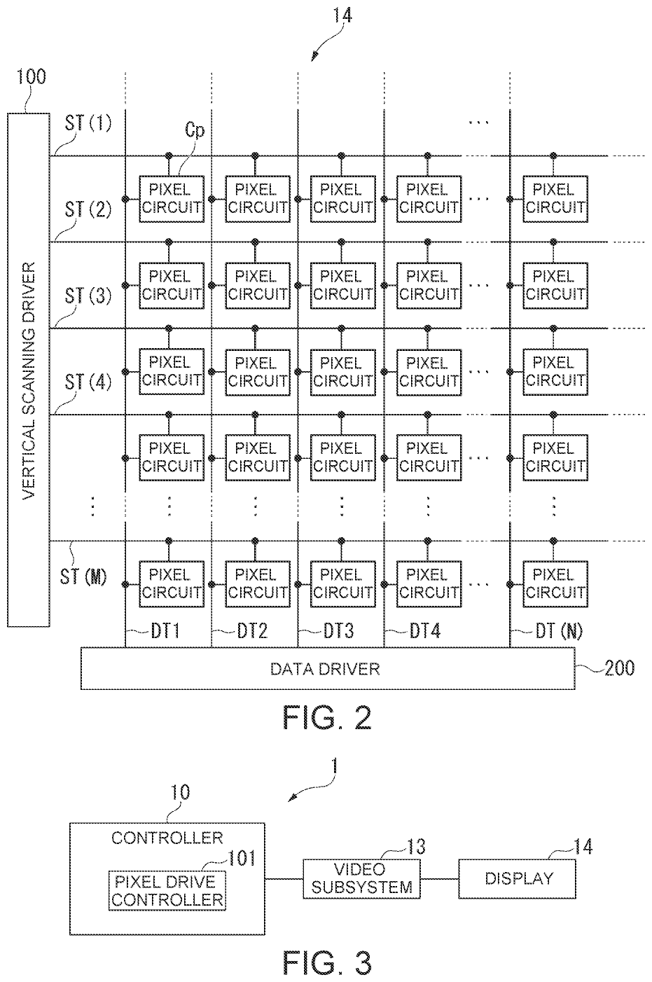

FIG. 2 illustrates an example the configuration of the display 14 that is a μLED display. The display 14 in the drawing illustrates an example of the configuration that is an active matrix scheme. For simplification of illustration and explanation, this drawing illustrates the configuration of a monochrome display with a single color, instead of three colors of R, G, and B.

In the display 14 of this drawing, M selection lines ST(1) to ST(M) extend in the horizontal (row) direction, and N data lines DT(1) to DT(N) extend in the vertical (column) direction.

In the following description, when no particular distinction is made between selection lines ST(1) to ST(M), they are referred to as selection lines ST, and when no particular distinction is made between the data lines DT(1) to DT(N), they are referred to as data lines DT.

A pixel circuit Cp is disposed at each of the intersections of the selection lines ST and the data lines DT. The pixel circuit Cp corresponds to one pixel. One pixel circuit Cp includes a display element as an LED, a TFT that lets the display element emit light, and a capacitor. The specific circuit configuration of the pixel circuit Cp is not particularly limited as long as it forms an active matrix.

A vertical scanning driver 100 sequentially scans (selects) selection lines ST(1) to ST(M) for each field (or frame) period. Specifically, the vertical scanning driver 100 outputs scanning signals (selection signals) to the selection lines ST(1) through ST(M) one by one for every field (or frame) period.

A data driver 200 outputs a data signal to each of the data lines DT at a predetermined timing in a period corresponding to one horizontal scanning period in which the scanning signal is output from a single selection line ST.

A single pixel circuit Cp becomes a state capable of retaining the electric charge corresponding to the data signal in the capacitor in response to a scanning signal being applied from the vertical scanning driver 100 to the selection line ST connected to the pixel circuit Cp. In this state, a data signal is applied from the data driver 200 to the data line DT connected to the pixel circuit Cp. Then the capacitor in the pixel circuit Cp retains the electric charge corresponding to the data signal, and the current corresponding to the retained electric charge flows to the LED that is the display element, causing the LED to emit light. In this way, one pixel is driven.

To display a UHD image, in one field (or frame) period, a scanning signal is first applied to the selection line ST(1) on the first row in one horizontal scanning period. In this state, data signals are applied to the data lines DT(1) to DT(N), whereby pixels corresponding to the pixel circuits Cp placed in the horizontal direction corresponding to the selection line ST(1) are driven to emit light. Thereafter, while a scanning signal is applied to the next selection line ST every one horizontal scanning period, data signals are applied to the data lines DT(1) to DT(N). As a result, the LED in each of the pixel circuits Cp placed in the horizontal direction corresponding to each selection line ST is driven to emit light at a brightness corresponding to the data signal in the order of the selection lines ST(2) to ST(M). That is, the pixels are driven on the display 14. In the present embodiment, “driving pixels” means applying the scanning signal and the data signal as described above, causing the LEDs in the pixel circuits Cp to emit light at a brightness corresponding to the data signal. As a result of driving pixels (image transfer) in this way, a one-field image with a resolution corresponding to UHD is displayed.

FIG. 3 illustrates an example of the functional configuration of the electronic apparatus 1, which relates to the pixel drive of the display 14 of this embodiment. The electronic apparatus 1 in this drawing includes a controller 10. This drawing illustrates the video subsystem 13 and the display 14 together with the controller 10.

The controller 10 executes control relating to pixel drive. In one example, the function as the controller 10 is implemented by the CPU 11 executing a program corresponding to the OS or BIOS.

The controller 10 includes a pixel drive controller 101. The pixel drive controller 101 executes control relating to driving pixels in the display 14. This drawing illustrates the configuration of the controller 10 that controls the display 14 via the video subsystem 13. In another configuration, the controller 10 may control the display 14 not via the video subsystem 13.

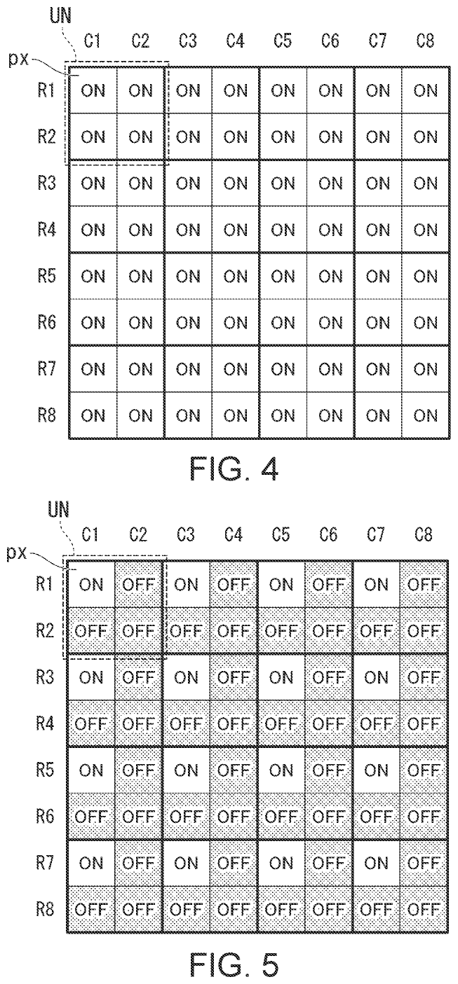

Referring to FIG. 4 and FIG. 5, the following describes an example of driving pixels in the display 14 in the electronic apparatus 1 of the present embodiment. For pixel driving of the display 14, the electronic apparatus 1 of the present embodiment is able to switch between pixel driving in a normal mode and pixel driving in a low power consumption mode.

The following describes an example where the electronic apparatus 1 displays either an image (UHD content) having a resolution (3840×2160) corresponding to the UHD standard or an image content (FHD content) having a resolution (1920×1080) corresponding to the FHD standard.

FIG. 4 illustrates an example of pixel driving in the normal mode. This drawing illustrates, among the pixels placed corresponding to the UHD standard resolution on the display 14, the array of the pixels px having eight rows X eight columns. One pixel px in the drawing corresponds to one pixel circuit Cp.

In this drawing, an array of pixels px with eight rows by eight columns has the row numbers R1 to R8 assigned from the top to the bottom of the rows, and the column numbers Cl to C8 assigned from the left to the right of the columns.

In the normal mode, the drawing describes “ON” in all the pixels px of eight rows X eight columns. The “ON” indicates that the corresponding pixel px is driven to display an image. That is, in the normal mode, all the pixels in the display 14 are driven to display an image.

In the normal mode, a UHD content is displayed at its original resolution. When displaying a UHD content in the normal mode, the pixel data forming a field screen of the UHD content and the pixels px in the display 14 have a one-to-one correspondence. In this case, each pixel px placed on the display 14 receives their data signal corresponding to the pixel data.

In the normal mode, the display 14 also is able to display a FHD content. When displaying a FHD content in the normal mode, as illustrated in the drawing, a pixel unit UN having pixels px of two rows by two columns is set in the entire array of pixels px. The example of the drawing includes the pixels px of eight rows by eight columns. In this case, the pixel units UN of four rows by four columns will be obtained.

In this case, the pixel data forming a field screen of the FHD content and the pixel units UN in the display 14 have a one-to-one correspondence.

When displaying a FHD content in the normal mode, a data signal corresponding to a common pixel data is applied to the four pixels px forming the pixel unit UN. This allows the display 14, which includes the pixels px in number corresponding to the resolution of the UHD content, to drive all of the pixels px and display the FHD content. This also allows the display 14 to display a UHD content having the resolution converted corresponding to the FHD content.

FIG. 5 illustrates an example of pixel driving in the low power consumption mode. The low power consumption mode displays an image with a lower power than in the normal mode.

Similarly to the displaying of a FHD content in the normal mode, the low power consumption mode sets a pixel unit UN having pixels px of two rows by two columns in the entire array of pixels px.

As illustrated in this drawing, “ON” is described in the upper left (1st row and 1st column) pixel px for each pixel unit UN. Then, “OFF” is described in the remaining three pixels px of 1st row and 2nd column, 2nd row and 1st column, 2nd row and 2nd column. The “OFF” indicates that the corresponding pixel px is not driven to display an image. That is, the low power consumption mode drives only one pixel px at a specific position for each pixel unit UN, and does not drive the remaining three pixel px.

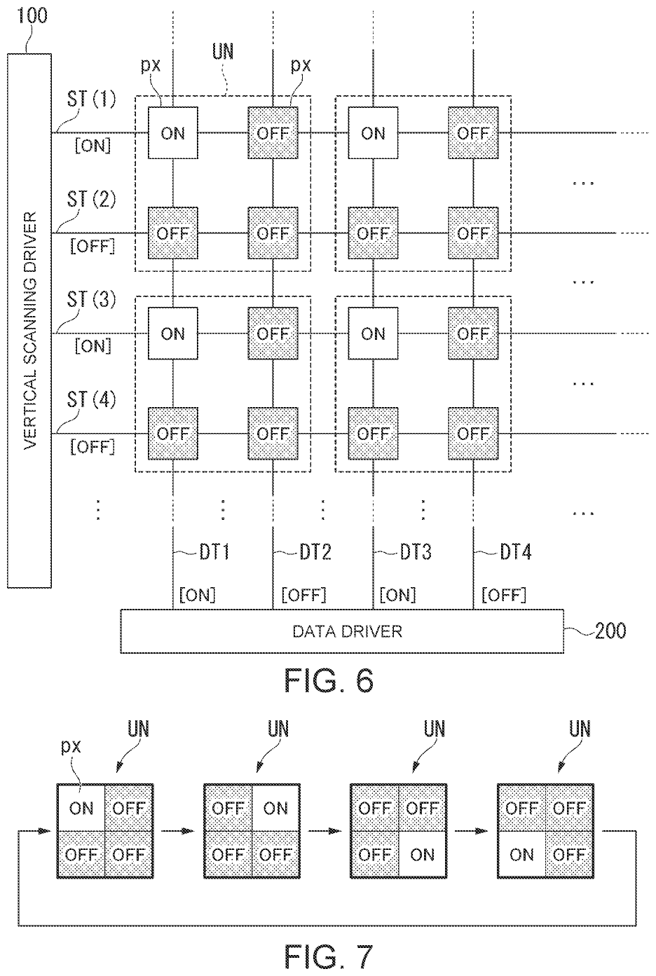

FIG. 6 illustrates driving of the pixels px in the low power consumption mode in terms of the relationship between the selection lines ST and the data lines DT. This drawing illustrates the four selection lines ST(1) to ST(4) in the first to fourth rows of M selection lines and the four data lines DT(1) to DT(4) in the first to fourth columns of the N data lines. This drawing also illustrates 16 pixels px so as to be placed corresponding to the intersections of the selection lines ST(1) to ST(4) and the data lines DT(1) to DT(4). This drawing also illustrates the vertical scanning driver 100 and the data driver 200.

This drawing, which illustrates the low power consumption mode, indicates that pixels px of two rows by two columns form a pixel unit UN, and the upper left pixel px only is driven and the remaining pixels px are not driven in each of the unit pixels UN similarly to FIG. 5.

To drive only the upper left pixel px in the pixel unit UN as in the drawing, the vertical scanning driver 100 and the data driver 200 apply signals to the selection lines ST and the data lines DT as follows.

That is, in a period of one field, the vertical scanning driver 100 first applies a scanning signal to the selection line ST(1) in the corresponding horizontal scanning period, but does not apply a scanning signal to the selection line ST(2) in the next horizontal scanning period. Then, the vertical scanning driver 100 applies a scanning signal to the selection line ST(3) in the next horizontal scanning period, but does not apply a scanning signal to the selection line ST(4) in the next horizontal scanning period. In the drawing, the selection lines ST to which the scanning signal is applied are indicated as [ON], and the selection lines ST to which the scanning signal is not applied are indicated as [OFF].

Also for the subsequent lines, the vertical scanning driver 100 similarly applies a scanning signal during the horizontal scanning period corresponding to the odd-numbered selection line ST (an example of the driven line), and does not apply a scanning signal during the horizontal scanning period corresponding to the even-numbered selection line ST, thus scanning of the selection lines ST every other line.

The data driver 200 applies data signals to the odd-numbered data lines DT(1), DT(3) . . . (an example of the columns to be driven) every other horizontal scanning period to apply a scanning signal to the selection lines ST. The data driver 200 does not apply a data signal to the even-numbered data lines DT(2), DT(4), . . . . In the drawing, the data lines DT to which the data signal is applied are indicated as [ON], and the data lines DT to which the data signal is not applied are indicated as [OFF].

To display an image, the scanning signals and the data signals are applied as described above, whereby as illustrated in the drawing, only the upper left pixel px of each of the unit pixels UN is driven in the entire array of pixels px.

Comparison of the brightness between the normal mode and the low power consumption mode is as follows. That is, the normal mode drives all of the four pixels px in each of the pixel units UN, and light is emitted with the brightness corresponding to their data signals. In contrast, the low power consumption mode drives only one pixel px in each of the pixel units UN to emit light with the brightness corresponding to the data signal. This means that, when a data signal of the same level as in the normal mode is applied in the low power consumption mode, the brightness of the displayed image as a whole is reduced to about ¼ of in the normal mode.

The present embodiment therefore may be configured so that, in the low power consumption mode, a data signal having a higher level may be applied so that the brightness four times as high as in the normal mode is obtained. This means that the LED in the driven pixel px emits light at the brightness four times the normal mode. That is, the pixel px emits light at the brightness four times the normal mode. As a result, the brightness of the entire image displayed in the low power consumption mode is the same as in the normal mode.

The low power consumption mode of driving the pixels as described above reduces the power consumption as compared with the normal mode as follows.

First, in the low power consumption mode, the number of driven pixels px is ¼ that of the normal mode, but the brightness of each pixel px is four times that of the normal mode. Therefore, it can be considered that the power consumption of the display elements (LEDs), which corresponds to the pixels px, placed on the display 14 as a whole does not change between the normal mode and the low power consumption mode.

Meanwhile, as understood from FIG. 6, the number of the selection lines ST to which the vertical scanning driver 100 applies a scanning signal in the unit period corresponding to one field in the low power consumption mode is ½ of that in the normal mode. Further, the data driver 200 applies a data signal only to the odd-numbered data lines DT every other horizontal scanning period. This means that the number of times the data driver 200 applies a data signal in one field period is ¼ of the normal mode.

In other words, when considering the entire array of LEDs corresponding to the pixels px, the power consumed by the entire LEDs for displaying an image does not change between the normal mode and the low power consumption mode. However, the power consumption for image transfer effectively reduces in the low power consumption mode because the number of selection lines ST to be driven is halved as compared with the normal mode, and the number of pixels px to which the data signal is applied becomes ¼ as compared with the normal mode.

Note here that the level of the data signal applied for image transfer to the pixels px to be driven in the low power consumption mode may be set higher than in the normal mode as described above, and may be set less than four times the normal mode.

In this way, the electronic apparatus 1 in the present embodiment is able to display images on the display 14 in either the normal mode or the low power consumption mode. To this end, the electronic apparatus 1 may be configured to switch between the normal mode and the low power consumption mode.

In one example, when switching from the normal mode to the low power consumption mode, the electronic apparatus 1 displays a UHD content on the display 14 in the normal mode. In this case, in response to the switch to the low power consumption mode, the electronic apparatus 1 may convert the resolution so as to correspond to the FHD content for displaying.

In another example, the electronic apparatus 1 displays the FHD content or the UHD content that has the resolution converted corresponding to the FHD content in the normal mode. In this case, the electronic apparatus 1 may keep the same resolution as in the normal mode to display an image even after the switch to the low power consumption mode.

The switching between the normal mode and the low power consumption mode may be made in response to a manual operation of a user.

Alternatively, the pixel drive controller 101 of the electronic apparatus 1 may perform switching between the normal mode and the low power consumption mode in response to a predetermined mode switching condition being satisfied. Examples of the mode switching condition for switching from the normal mode to the low power consumption mode include the followings.

For example, the mode switching condition for switching from the normal mode to the low power consumption mode may be that the electronic apparatus 1 receives electricity from the battery 29. Specifically, the pixel drive controller 101 sets the normal mode when the electricity is supplied from the AC adapter, but sets the low power consumption mode when the electricity is supplied from the battery 29. In other words, the mode switching condition for switching from the low power consumption mode to the normal mode is that the electronic apparatus 1 receives electricity from the AC adapter.

For example, the mode switching condition for switching from the normal mode to the low power consumption mode may be that the electronic apparatus 1 receives electricity from the battery 29 and the remaining amount of the battery 29 is below a certain level. In this case, the pixel drive controller 101 sets the normal mode when the electronic apparatus 1 receives electricity from the AC adaptor, or when the electronic apparatus 1 receives electricity from the battery 29 and the remaining amount of the battery 29 is a predetermined level or more. The pixel drive controller 101 sets the low power consumption mode when the remaining amount of the battery 29 is the predetermined level or less.

In other words, the mode switching condition for switching from the low power consumption mode to the normal mode is either that the electronic apparatus 1 receives electricity from the battery 29 and the remaining amount of the battery 29 is the predetermined level or more, or that the electronic apparatus 1 receives electricity from the AC adapter.

For example, the mode switching condition may be changed according to the operation of the user. In one example, the default setting is such that the remaining amount of the battery 29 is the predetermined value or less. The remaining amount of the battery for switching to the low power consumption mode may be changed according to the user's operation. Alternatively, the operation mode may be fixed to the normal mode or the low power consumption mode according to the user's operation.

### MODIFIED EXAMPLES

The following describes additional embodiments (modified examples) of the present embodiment.

### First Modified Example

The above embodiment is configured so that the upper left pixel px of the pixel unit UN with two rows by two columns is always driven in the low power consumption mode.

This modified example is configured so that, in the low power consumption mode, the position of one pixel px to be driven in each of the pixel units UN having two rows by two columns changes every time a predetermined condition (driving pixel change condition) is satisfied.

FIG. 7 illustrates an example of changing the position of a pixel px driven in a pixel unit UN in the low power consumption mode.

This drawing illustrates an example of the pattern (intra-unit pixel driving pattern) of the position of one pixel px driven in each of the pixel units UN in the low power consumption mode. In this example, the pattern changes cyclically in a clockwise order from upper left, upper right, lower right, to lower left every time the driving pixel change condition is satisfied. Such a change in the intra-unit pixel driving pattern may be controlled by the pixel drive controller 101 in the electronic apparatus 1.

The order of changing these four intra-unit pixel driving patterns is not limited to the example in the drawing, and any order may be set. For example, although the drawing illustrates the example of changing the position of one driven pixel px to move in the clockwise direction, the position may be changed to move in the counterclockwise direction. In another example, the position of one driven pixel px may move diagonally like upper left, lower right, lower left and upper right.

Such changing the intra-unit pixel driving patterns makes the deterioration of the display element corresponding to the pixel px, which is due to light emission of the display element, uniform over the entire screen of the display 14. That is, this reduces the burn-in of the screen of the display 14. The display 14 may have a structure of sealing the display elements with resin. In this case, changing the intra-unit pixel driving patterns makes the progress of yellowing of the resin uniform or mitigates the progress.

In this modified example, the driving pixel change condition may be determined based on the display time as follows.

For example, the driving pixel change condition may be set so that the cumulative time of the image display in one intra-unit pixel driving pattern in the low power consumption mode reaches a certain level or longer.

Alternatively, the driving pixel change condition may be set so that, regardless of the low power consumption mode and the normal mode, the cumulative time of image display reaches a certain level or longer.

Alternatively, the driving pixel change condition may be simply set so that, regardless of whether or not an image is displayed, a certain duration of time has simply elapsed since the display of one intra-unit pixel driving pattern starts.

Note that the intra-unit pixel driving pattern can be changed (switched) while an image is being displayed. However, if the intra-unit pixel driving pattern is switched while an image is being displayed, such a change in the image may cause discomfort to the user. In this case, the user may misunderstand that the electronic apparatus 1 has a failure. For this reason, the timing for switching the intra-unit pixel driving pattern is preferably not during the display of an image, but at the timing when the display of an image starts from a state of no image being displayed.

Then, the pixel drive controller 101 may set the driving pixel change condition so that after the display time has elapsed as described above, the display of an image on the display 14 starts from the state of no image being displayed, for example.

In one example, the above-mentioned state that “the display of an image on the display 14 starts from the state of no image being displayed” means the state where the power turns on from the off state and the electronic apparatus 1 is activated, or the state of resuming from a sleep state or a hibernation state. The above-mentioned state that “the display of an image on the display 14 starts from the state of no image being displayed” as the driving pixel change condition may include both the state where the power turns on from the off state and the state of resuming from a sleep state or a hibernation state as stated above, or may include one of them.

The driving pixel change condition may not include the elapse of the display time, but may simply be that the display of an image starts from a state of no image being displayed on the display 14.

### Second Modified Example

In the above embodiment, one pixel px is driven in each pixel unit UN having a plurality (four) pixels px in the low power consumption mode. In this modified example, a plurality of pixels px is driven in each unit pixel UN.

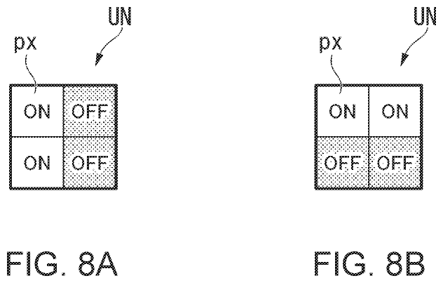

FIG. 8 illustrates a specific example of the intra-unit pixel driving pattern of this modified example. FIG. 8A illustrates the intra-unit pixel driving pattern configured so that the upper left and lower left two pixels px are driven in a single pixel unit UN having two rows by two columns, and the remaining upper right and lower right two pixels px are not driven.

Instead of this mode of the drawing, the intra-unit pixel driving pattern may be configured so that the upper right and lower right two pixels px are driven in the pixel unit UN, and the remaining upper left and lower left two pixels px are not driven.

That is, FIG. 8A illustrates an example of the intra-unit pixel driving pattern that drives one of the two columns in the pixel unit UN.

Such an intra-unit pixel driving pattern is implemented by driving pixels px so that scanning signals are applied to all selection lines ST from the vertical scanning driver 100 and data signals are applied to the odd-(or even-) numbered data lines DT from the data driver 200. To keep the same brightness of the entire image as in the normal mode, this example applies a data signal at a level that doubles the brightness of each of the two driven pixels px in the normal mode to the data lines DT.

FIG. 8B illustrates the intra-unit pixel driving pattern configured so that the upper left and upper right two pixels px are driven in a single pixel unit UN having two rows by two columns, and the remaining lower left and lower right two pixels px are not driven.

Instead of this mode of the drawing, the intra-unit pixel driving pattern may be configured so that the lower left and lower right two pixels px are driven in the pixel unit UN, and the remaining upper left and upper right two pixels px are not driven.

That is, FIG. 8B illustrates an example of the intra-unit pixel driving pattern that drives one of the two columns in the pixel unit UN.

Such an intra-unit pixel driving pattern is implemented by driving pixels px so that scanning signals are applied to the odd- (or even-) numbered selection lines ST from the vertical scanning driver 100 and data signals are applied to all data lines DT from the data driver 200. To keep the same brightness of the entire image as in the normal mode, this example applies a data signal at a level that doubles the brightness of each of the two driven pixels px in the normal mode to the data lines DT.

For the driving of pixels px in the low power consumption mode as in FIG. 8A and FIG. 8B, the power consumption of the display elements (LEDs), which corresponds to the pixels px, as a whole does not change from the power consumption in the normal mode. For image transfer in the low power consumption mode, however, the number of data lines ST to be driven is halved in FIG. 8A, and the number of selection lines ST to be driven is halved in FIG. 8B. That is, in both cases of FIG. 8A and FIG. 8B, the number of driven pixels px is halved as compared with the normal mode, and thus the power consumption can be reduced.

The pixel drive controller 101 of this modified example may be configured to change the pixel driving pattern of the pixel unit UN having two rows by two columns in the low power consumption mode so that it switches between the pattern of driving one pixel px as in the embodiment as described above and the pattern of driving two pixels px as in this modified example. That is, the low power consumption mode may have a plurality of patterns of pixel driving in which the number of pixels px to be driven in the same pixel unit UN differs. In this case, the pixel drive controller 101 may change the plurality of pixel drive patterns in such a way that the number of pixels px to be driven in the pixel unit UN decreases in accordance with the decrease in the remaining amount of the battery 29 in the low power consumption mode.

Specifically, the pixel drive controller 101 first sets the normal mode when the remaining amount of the battery 29 is greater than a first threshold. When the remaining amount of the battery 29 is in the range of the first threshold or less and greater than a second threshold, the pixel drive controller 101 sets a pattern of driving two pixels px in the pixel unit UN of two rows by two columns as illustrated in FIG. 8. When the remaining amount of the battery 29 is the second threshold or less, the pixel drive controller 101 sets a pattern of driving one pixel px in the pixel unit UN, as illustrated in FIG. 5.

Such a switching of the pixel driving pattern between the normal mode and the low power consumption mode with multiple stages can be considered as a switching that changes the number of pixels px to be driven in the pixel unit UN.

### Third Modified Embodiment

The pattern of placing the pixels px forming the pixel unit UN is not limited to two rows by two columns in the above embodiment, as long as a plurality of pixels px is placed in the pixel unit UN. In this case, the rows and columns of the pixels px forming the pixel unit UN need not be the same in number, which may be two rows by three columns, for example.

### Fourth Modified Embodiment

The low power consumption mode may have a plurality of stages. In one specific example, the low power consumption mode may have two stages, a first stage and a second stage, as follows. The first stage has an intra-unit pixel driving pattern of driving one pixel px with the brightness four times the normal mode in the pixel unit UN of two rows by two columns as in the above embodiment. The second stage has an intra-unit pixel driving pattern of driving one pixel px with the brightness nine times the normal mode in the pixel unit UN of three rows by three columns, for example. In other words, this is an example of driving one pixel px in the pixel unit UN, although the number of pixels px forming the pixel unit UN is different between the stages in the low power consumption mode.

In comparison of the power consumption for image transfer, the power consumption of the pixel drive pattern in the first stage is ¼ of that in the normal mode, while the power consumption of the pixel drive pattern in the second stage is 1/9 of that in the normal mode. Therefore, the second stage consumes less power than the first stage.

Therefore, the pixel drive controller 101 of the electronic apparatus 1 sets the normal mode first to display an image on the display 14 when the remaining amount of the battery 29 is greater than a first threshold. When the remaining amount of the battery 29 is in the range of the first threshold or less and greater than a second threshold, the pixel drive controller 101 may change the display to the first stage in the low power consumption mode. Then in response to the remaining amount of the battery 29 becoming the second threshold or less, the pixel drive controller 101 may change the display to the second stage in the low power consumption mode. The first threshold and the second threshold value in this modified example may be set to actual values that are different from the first threshold and the second threshold in the second modified example.

In another example, the user may set so as not to execute the display in the normal mode and to execute switching between multiple stages in the low power consumption mode according to the remaining amount of the battery 29, for example.

### Fifth Modified Example

The display elements of the display 14 are not limited to LEDs as long as they are a self-luminous display elements. Examples of the display elements include organic electro luminescence (EL).

### Sixth Modified Example

The electronic apparatus 1 of the above-described embodiment is of a portable type such as a clamshell type personal computer, a tablet, or a smartphone, and has a display device that is integral with the chassis. The electronic apparatus according to the present embodiment may include a main body and a display device, which are independent devices, connected to each other, as in a desktop personal computer. The electronic apparatus according to the present embodiment may be a television receiver, a monitor display for displaying an input image, or the like.

That is a detailed description on the embodiment of the present disclosure with reference to the drawings, and the specific configuration of the present disclosure is not limited to the above-described embodiments, and also includes design modifications or the like within the scope of the present disclosure. The configurations described in the above embodiment and modified examples can be combined as needed unless such a combination is inconsistent with present disclosure.

1. A pixel drive control device configured to control driving of an array of pixels in M (where M≥2) rows and N (where N≥2) columns on a display device, comprising:
a pixel drive controller configured to control driving a part of pixels in each of pixel units, each of the pixel units including two or more pixels in m (where m≤M) rows and n (where n≤N) columns and being set in the array of pixels in the M rows and the N columns.

2. The pixel drive control device according to claim 1, wherein
the pixel drive controller controls to apply a scanning signal to a driving target row among the M rows, the driving target row including a pixel to be driven in each pixel unit, and not to apply a scanning signal to a row other than the driving target row, and
the pixel drive controller controls to apply a data signal to a driving target column among the N columns, the driving target column including a pixel to be driven in each pixel unit, and not to apply a data signal to a column other than the driving target column.

3. The pixel drive control device according to claim 1, wherein the pixel drive controller applies a data signal at a higher level than a data signal that is applied to drive all pixels in the pixel unit.

4. The pixel drive control device according to claim 3, wherein the pixel drive controller applies a data signal at a level based on a ratio of the number of the part of pixels driven in each pixel unit to the number of all the pixels in the pixel unit.

5. The pixel drive control device according to claim 1, wherein the pixel drive controller, in response to a predetermined condition being satisfied, performs switching between controlling to drive all the pixels in the pixel unit and controlling to drive the part of pixels in the pixel unit.

6. The pixel drive control device according to claim 1, wherein the pixel drive controller, in response to a predetermined condition being satisfied, changes a part of pixels to be driven in each pixel unit.

7. A pixel drive control method that controls driving of an array of pixels in M (where M≥2) rows and N (where N≥2) columns on a display device, comprising
controlling to drive a part of pixels in each of pixel units, each of the pixel units including two or more pixels in m (where m≤M) rows and n (where n≤N) columns and being set in the array of pixels in the M rows and the N columns.
